(19) United States
(12) Patent Application Publication
(10) Pub. No.: US 2008/0103923 A1
(43) Pub. Date: May 1, 2008

(54) Centralized Payment Gateway System and Method

(75) Inventors: Keith A. Rieck, Roseville, MN (US); Igor A. Korolev, Eden Prairie, MN (US); Andrew Vernon Barker, Hopkins, MN (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 11/925,596

(22) Filed: Oct. 26, 2007

Related U.S. Application Data
(60) Provisional application No. 60/863,734, filed on Oct. 31, 2006.

(51) Int. Cl. G06Q 30/00; G06Q 20/00

(52) U.S. Cl. 705/26; 705/1

(57) ABSTRACT

As a company acquires commerce platforms the maintenance of integrations with payment service providers becomes an issue. The best thing is to keep the amount of developers needed to a minimum and reduce transaction costs to a minimum; therefore a centralized code base is best for a company. A gateway is described that allows a company to expose a web service based application programming interface (API) to the integrating commerce platforms. This allows for a simple standardized integration for all available payment methods with out the commerce platform about the payment service provider. This removes the complexity and redundant integrations that each platform needs to have with each of the payment service providers. An advanced arbitration engine allows for the gateway to decide what the best cost based payment service to use for the transaction.

This application claims the benefit of U.S. Provisional Application No. 60/863734 filed 31 Oct. 2006, entitled “Centralized Payment Gateway,” which is incorporated herein by reference.

### FIELD OF THE INVENTION

The present invention relates to a method and system for enhancing access to a payment service provider. The invention is particularly apt for providing an arbitration forum to a payment service provider with a centralized gateway.

### BACKGROUND OF THE INVENTION

The link between a real person and their simulated extensions in cyberspace is fragile. The time of walking into a shop, choosing goods, and purchasing the goods by paying a live cashier or shopkeeper is gradually becoming a bygone era.

Utilization of the Internet continues to rise at a rapid pace. Indeed, business and governmental entities as well as individuals are increasingly relying upon the Internet for research, communication, entertainment and transactional purposes. Access to the Internet network is provided by Internet servers. Such servers are typically maintained by an Internet Service Provider (ISP) who offers “use” of its servers to customers on a pre-determined, subscription basis. Basically, an ISP is a business or organization that sells access to the internet and other related services.

In addition, a payment service provider (PSP) offers merchants online services for accepting electronic payments by credit card or other payment methods such as payments based on online banking. Typically, a PSP can connect to multiple acquiring banks and card networks, thereby making the merchant less dependent of financial institutions—especially when operating internationally. Furthermore, a PSP can offer reconciliation services, risk management and multi-currency functionality.

Along the same lines, payment gateways are a category of agent or service provider that stores, processes, and/or transmits cardholder data as part of a payment transaction. Specifically, they enable payment transactions (e.g., authorization or settlement) between merchants and processors (endpoints). Merchants may send their payment transactions directly to an endpoint, or indirectly to a payment gateway.

Access to information and movement around the Internet is enhanced through the use of hyperlinks (“links”) within a web page's hypertext markup language (HTML). The link, which is typically a word in a text field or an image on a web page, acts as a path that moves a user from one web page address, Uniform Resource Locator (URL), to another web page address on a web site. The movement from one URL to another allows near-instant access to information, products, and services and is particularly well-suited to the exchange of information, goods, and services between buyers and sellers. Such business is commonly referred to as “e-commerce,” or “electronic commerce.”

The current state of e-commerce is a state of confusion; many people are losing a great deal of money. Only few make any profit, mostly due to a poor set of products and tools. For instance, there are credit card security issues, limited ways to pay for merchandise, older browser versions, and sites that do not update their catalogs. E-commerce web sites sell products, such as goods or services, online. They both display the products for sale and provide an easy way to complete a sales transaction. This usually involves credit card verification and automatic merchant account processing.

There are two levels of e-commerce sophistication: static and dynamic. In static, separate web pages exist for each product usually with a picture, a description, and a price. Each time the user wants to change product information they change the product's web page and upload it to the website. “Shopping Cart” functionality is a user-friendly feature and is included as standard equipment in every e-commerce hosting plan.

If the user already has a website that they are happy with, and are only selling a small number of items, then a shopping cart application maybe suitable. A shopping cart enables the existing web site to take orders, and sends those orders to another application for processing. Usually, the user will have to add HTML code to the web site after every product description. (This is often referred to as “bolt-on” software.) The code will create buttons and boxes that will allow the customers to select colors, sizes and quantities, place an order, and check out. Most will allow the user to choose a design template and will then create product and category pages that already include shopping cart functions. The software generally includes a database so that adding products and updating product information requires no knowledge of HTML. The software can either be licensed outright, or rented by the month from an ASP.

These web sites can be free, meaning that there are no monthly hosting fees and there are no development costs; easy to use point-and-click templates are provided by the host. However, some costs are involved, such as per transaction fees and merchant account setup fees. In contrast, the dynamic ones have product information stored in a database and displayed dynamically per users' requests. These are never free; users must pay a monthly hosting fee and develop these sites professionally.

In addition, there are several different ways to receive funds online. A user can travel down the time-consuming yet intellectually rewarding path of building their own shopping cart. But if the user does not have programming muscles to flex, let alone the time to build something, a web storefront service maybe the way to go. When moving currency from one party to another is involved, the time, money, and craftiness needed to implement them varies. Thus, payment systems may need to utilize certain mechanisms to help smooth the process of receiving funds online.

Simple Object Access Protocol (SOAP) provides a simple and lightweight mechanism for exchanging structured and typed information between peers in a decentralized, distributed environment using extensible markup language (XML). SOAP does not itself define any application semantics such as a programming model or implementation specific semantics; rather it defines a simple mechanism for expressing application semantics by providing a modular packaging model and encoding mechanisms for encoding data within modules. This allows SOAP to be used in a large variety of systems ranging from messaging systems to remote procedure calls (RPC).

SOAP consists of three parts: The SOAP envelope construct defines an overall framework for expressing what is in a message; who should deal with it, and whether it is optional or mandatory. The SOAP encoding rules defines a serialization mechanism that can be used to exchange instances of application-defined datatypes. The SOAP RPC representation defines a convention that can be used to represent remote procedure calls and responses.

Additionally, W3C defines a Web service as a software system designed to support interoperable Machine to Machine interaction over a network. Web services are frequently just Web APIs that can be accessed over a network, such as the Internet, and executed on a remote system hosting the requested services.

The W3C Web service definition encompasses many different systems, but in common usage the term refers to clients and servers that communicate using XML messages that follow the SOAP standard. Common in both the field and the terminology is the assumption that there is also a machine readable description of the operations supported by the server, a description in the Web Services Description Language (WSDL). The latter is not a requirement of a SOAP endpoint, but it is a prerequisite for automated client-side code generation in the mainstream Java and .NET SOAP frameworks. Some industry organizations, such as the WS-I, mandate both SOAP and WSDL in their definition of a Web service.

Web services are a set of tools that can be used in a number of ways. The three most common styles of use are RPC, SOA and REST. Architectural elements involved in the XML-RPC. RPC Web services present a distributed function (or method) call interface that is familiar to many developers. Typically, the basic unit of RPC Web services is the WSDL operation.

The first Web services tools were focused on RPC, and as a result this style is widely deployed and supported. However, it is sometimes criticised for not being loosely coupled, because it was often implemented by mapping services directly to language-specific function or method calls . . . Many vendors felt this approach to be a dead end, and pushed for RPC to be disallowed in the WS-I Basic Profile.

Web services can also be used to implement architecture according to Service-oriented architecture (SOA) concepts, where the basic unit of communication is a message, rather than an operation. This is often referred to as “message-oriented” services.

SOA Web services are supported by most major software vendors and industry analysts. Unlike RPC Web services, loose coupling is more likely, because the focus is on the “contract” that WSDL provides, rather than the underlying implementation details.

Finally, RESTful Web services attempt to emulate HTTP and similar protocols by constraining the interface to a set of well-known, standard operations (e.g., GET, PUT, DELETE). Here, the focus is on interacting with stateful resources, rather than messages or operations.

RESTful Web services can use WSDL to describe SOAP messaging over HTTP, which defines the operations, or can be implemented as an abstraction purely on top of SOAP (e.g., WS-Transfer).

There is a need for a system that allows a company to expose a simple web service based application programming interface (API) to the integrating commerce platforms. This would allow for a simple standardized integration for all available payment methods with out the commerce platform needing to know anything about the payment service provider. Also, there is a need to reduce the complexity and redundancy integrations that each platform needs to have with each of the payment service providers. Furthermore, a feature that allows for a centralized payment gateway (CPG) to decide what the best cost based payment service to use for the transaction would be beneficial and useful. The present invention provides a solution to these needs and other problems, and offers other advantages over the prior art.

### BRIEF SUMMARY OF THE INVENTION

As a company acquires more and more commerce platforms the maintenance of the integrations with the many payment service providers may become an issue. This is because the maintenance is mostly redundant. The best thing is to keep the amount of developers needed to a minimum and reduce transaction costs to a minimum. A centralized code base is the best plan for an ecommerce company as a whole.

Centralized payment gateway (CPG) is a middleware or gateway that allows an ecommerce company to expose a simple web service based application programming interface (API) to integrating commerce platforms. This allows for a simple standardized integration for all available payment methods without the commerce platform needing to know anything about the payment service provider. A message to CPG may state what method, currency, amount and country and CPG will do all the work to complete the payment process. This removes the complexity and redundant integrations that each platform needs to have with each of the payment service providers. Another important feature is an advanced arbitration engine that allows for CPG to decide what the best cost based payment service or PSP to use for a particular transaction. For example, a commerce platform wants to send an order for 80.00 EUR from a French customer paying with Visa. CPG, with the advanced arbitration engine, would analyze and decide that using, for instance, NetGiro and BNP to process the transaction would obtain the best interchange rate thus saving a company millions of dollars in transaction fees. It will be understood that NetGiro and BNP are used by means of an example and that other business or systems may be substituted.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates an overview diagram of Centralized Payment Gateway (CPG) system and method.

FIG. 2 shows a diagram of CPG used in conjunction with payment processors and payment adapters.

FIG. 3 shows a flowchart for direct processing of authorizations against a conventional credit card payment service.

FIG. 4 illustrates a flowchart, by way of example, of a PayPal authorization scheme.

FIG. 5 shows a data flow diagram of payment adapters configured with a database table

FIG. 6 illustrates a data diagram of persistent classes that function in the backend of CPG.

FIG. 7 shows a data diagram of persistent classes stored in an Oracle database that function in the backend of CPG.

### DETAILED DESCRIPTION

Centralized payment gateway (CPG) is a middleware or gateway that allows an ecommerce company to expose a simple web service based application programming interface (API) to an integrating commerce platforms. This allows for a simple standardized integration for all available payment methods without the commerce platform needing to know anything about the payment service provider. A message to CPG may state what method, currency, amount and country and CPG will do all the work to complete the payment process. This removes the complexity and redundant integrations that each platform needs to have with each of the payment service providers. Another important feature is an advanced arbitration engine that allows for CPG to decide what the best cost based payment service to use for the transaction. Outlined below are a few commonly used terms in the preferred embodiment of CPG system and method.

### Common Terms Used

Payment Adapter: A transaction-processing environment that manages transaction integrity for payment schemes. Payment adapters can support communications to multiple systems including: Acquirer Banks, Issuer Banks, Merchants, Corporate Customers and Cardholders, making it a central component of a secure electronic funds transfer infrastructure. Typically, one adapter is made available for each payment processor. A payment adapter requests the payment object, formats it, and sends it to the payment processor. The payment adapter also processes the payment processor's response, persists it, and returns the results to a client.

Account token: A string of characters representing a customer's credit card. This token allows CPG to track customers while minimizing exposure of the credit card number. The token may be used in reporting or in fraud detection. The combination of division identification (ID) and account token will always be unique. However, if CPG detects that the same payment account is being used on two different divisions, it will attempt to give both accounts the same token.

Redirect: Causing a customer's browser to connect to a different web site. For instance, to do PayPal processing, CPG will redirect customers to the PayPal site, with the expectation that PayPal will later direct them back to the original site.

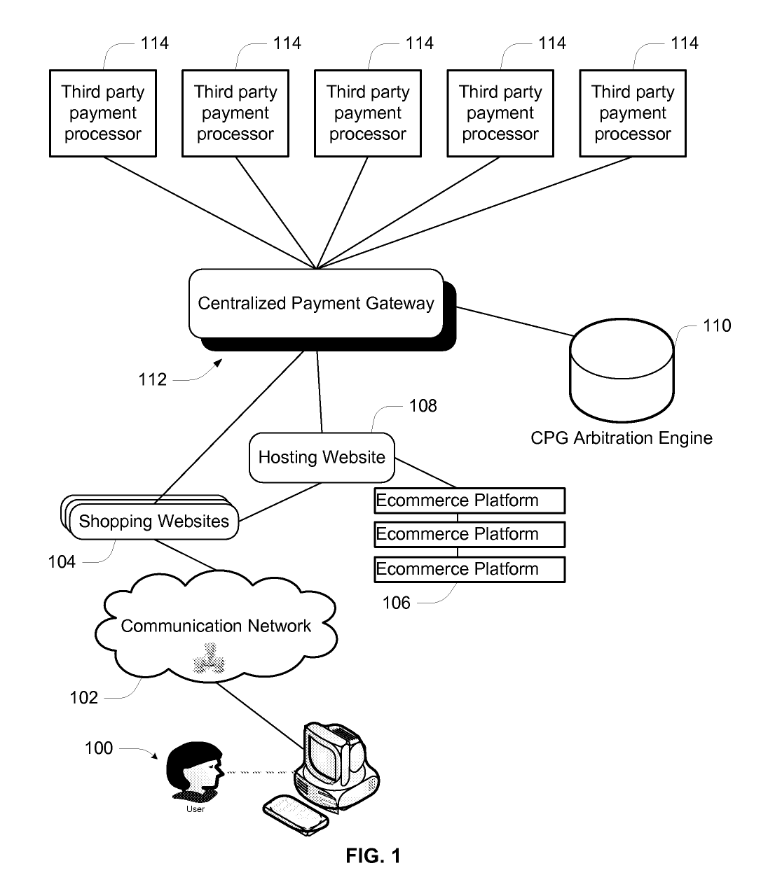

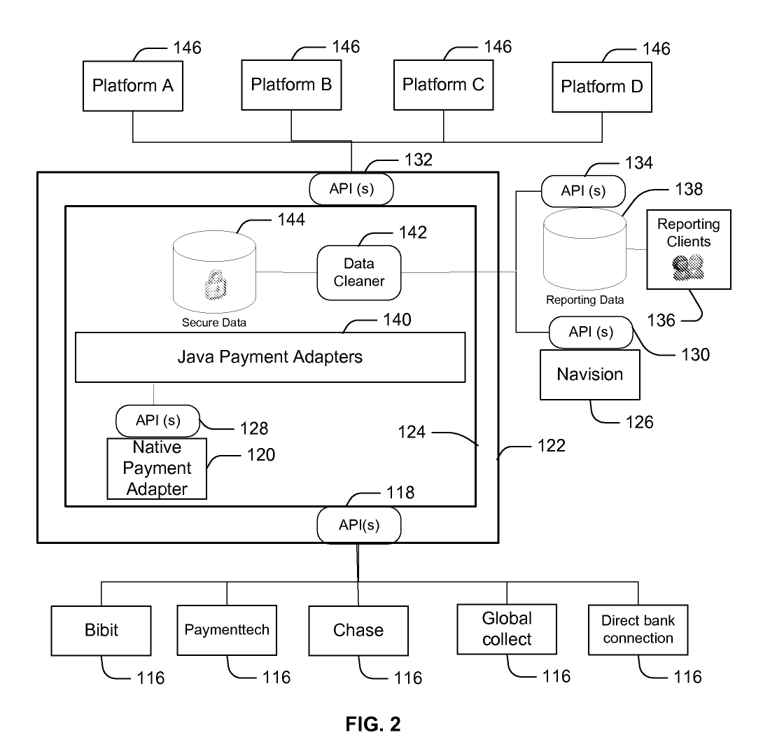

FIG. 1 illustrates an overview diagram of Centralized Payment Gateway (CPG) system 112. In a preferred embodiment, CPG 112 communicates with third party payment processors 114 to choose a suitable payment processor through CPG Arbitration Engine 110. A customer 100 initiates a purchase over a communication network 102 through a shopping site 104 which is hosted by a hosting website 108. It will be understood by one of ordinary skill in the art that a shopping site does not need to be hosted. It will also be understood that a customer may be a user, a shopper, or an administrator, but is not limited to these roles. The hosting website 108 may be owned by an ecommerce business or company (not shown) that has at least one ecommerce platform 106. It will be understood that FIG. 1 is a symbolic summary of how CPG system and method 112 works, and that the backend processes of the arbitration engine 110 are shown in more detail in FIGS. 2-7.

FIG. 2 shows a diagram of CPG used in conjunction with payment processors 116 and java payment adapters 140. Specifically, FIG. 2 describes how CPG is a Java application 122 deployed separately from a company's e-commerce platforms 146 and will have its own database tables. The ecommerce platforms 146 will access CPG using web service protocols. In a preferred embodiment, it will communicate with payment processors 116 through java payment adapters 140. Basically, the java payment adapters 140 work through API 128 to a native payment adapter 120. It will be understood by one of ordinary skill in the art that an API is an abbreviation for application programming interface, an interface by which an application program acesses operating systems and other services. An API is defined at source code level and provides a level of abstraction between an application and a kernal (or other priviliged utilities) to ensure the portability of the code.

Again referring to FIG. 2, secure data 144 and data cleaner 142 communicate with APIs 134 and 130 to report data 138 to reporting clients 136. It will be understood by one of ordinary skill in the art that a financial accounting system (such as Microsoft Navision, for example) 126 works with API 130. Within area 124 CPG system the core functionality with native APIs is located and area 122 of CPG system has APIs 132 and 118 that function to externally communicate with the payment processors 116 and platforms 146.

### Typical Payment Process

Store Account information: During checkout, the ecommerce platform sends the credit card number to CPG and gets a token back. The ecommerce platforms typically do not store credit card numbers or other sensitive information. The ecommerce system uses tokens to represent payment account numbers instead of storing the actual number. Subsequent payment transactions use this token instead of the sensitive account numbers. If the same credit card is used on multiple transactions, it will be represented by the same token. This use of the same token supports fraud tracking and reporting.

Authorize: During checkout, the ecommerce platform authorizes payment using the account token. CPG will communicate back to the payment processor to verify the credit information and reserve money for the payment.

Settle: After the order is fulfilled, the ecommerce platform requests that money be transferred. Typically, settlements are sent in batches.

Furthermore, every communication between CPG and a payment provider is recorded as a “payment transaction”. There are separate transactions for authorization, settlement, refunds, etc. Transactions record the order ID, so one can see the total payment status of an order by looking up all transactions for a given order ID. Each payment transaction has a current status. It will change status during communication with the payment processor. There are five kinds of basic transactions, as shown in Table 1.

TABLE 1

| Transaction Type | Description | Statuses |
|---|---|---|
| Authorize | Reserve the specified funds. No purchase | New, Completed, |
| | has taken place, but one is imminent. | Failed, Submitted, |
| | | Submitting, Cancelled |
| Settle | Settle the specified amount. The | New, Completed, |
| | settlement will reference a previously | Failed, |
| | completed authorization. A settlement | Submitted, |
| | transaction should always be the result of a | Submitting, Cancelled |
| | business exchange (e.g., a sale) between | |
| | the selling company and buyer. | |
| Refund | The e-commerce system initiates a refund | New, Completed, |
| | of previously settled money to a customer. | Failed, Submitted, |
| | | Submitting, Cancelled |
| Cancellation | Cancel a previous transaction. | New, Completed, |
| | | Failed. |
| Chargeback | After a customer has complained to the | New, Completed, |
| | payment provider, the payment provider | Failed, Submitted, |
| | takes money from the ecommerce system. | Submitting, |
| | Also called a “Reversal”. | Cancelled, Dispute |
| | | resolved |

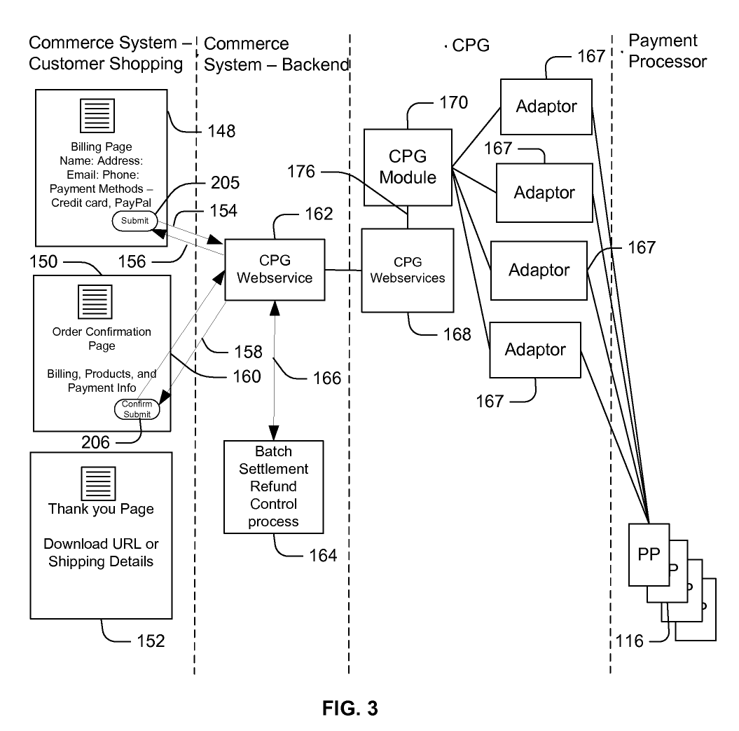

FIG. 3 shows a page flow for direct processing of authorizations against a conventional credit card payment service. The customer enters their credit card number into a billing page 148 and selects a payment type. The payment type could be credit card, checking account transfer, PayPal, etc. It will be understood by one of ordinary skill in the art that there are various payment types. In a preferred embodiment of CPG, the ecommerce system then stores the payment type information, such as a credit card (for example) into CPG webservice 162 and receives a token in return. A flow for this Store request 154 and store response 156 is shown in FIG. 3. Next, the customer sees an order confirmation page 150. After the user confirms 206 that they wish to order, the ecommerce system asks CPG webservice 162 to authorize for the requested amount of money. A flow for this Authorize Request 160 and Authorize Response 158 is shown in FIG. 3. On click or after user selection, an order goes through export controls and pre-authorization fraud check. On sucessful authorization of payment, the order will be submitted for fullfillment. CPG webservice 162 communicates 166 with a Batch Settlement Refund Control 164. CPG module 170 uses payment service adapters 167 to communicate to corresponding payment services 116. It will be understood that these adapters 167 could be Java payment service adapters. The adapters 167 authorize payment and process settle batch. CPG module 170 also communciates with CPG webservices 168 to manage the communication with the payment services 116.

Furthermore, if authorization is successful, CPG (collectively CPG module 170 and CPG webservices 168) marks the authorization transaction as “Completed” and sends back the authorization code. It will be understood that CPG module 170 and CPG webservices 168 work together 176 to accomplish the authorization. Upon reaching a thank-you page 152, the ecommerce system can mark this order as having been authorized for payment, and download URL or shipping details. The billing page 148, order confirmation page 150, and thank-you page 152 are all part of the commerce system customer shopping section. The CPG webservice 162 and Batch Settlement Refund control 164 function in the backend of the commerce system. CPG module 170, CPG webservices 168, and the adapters 167 are CPG collectively. Finally, the payment processors 116 are the section at the end of the flow diagram in FIG. 3.

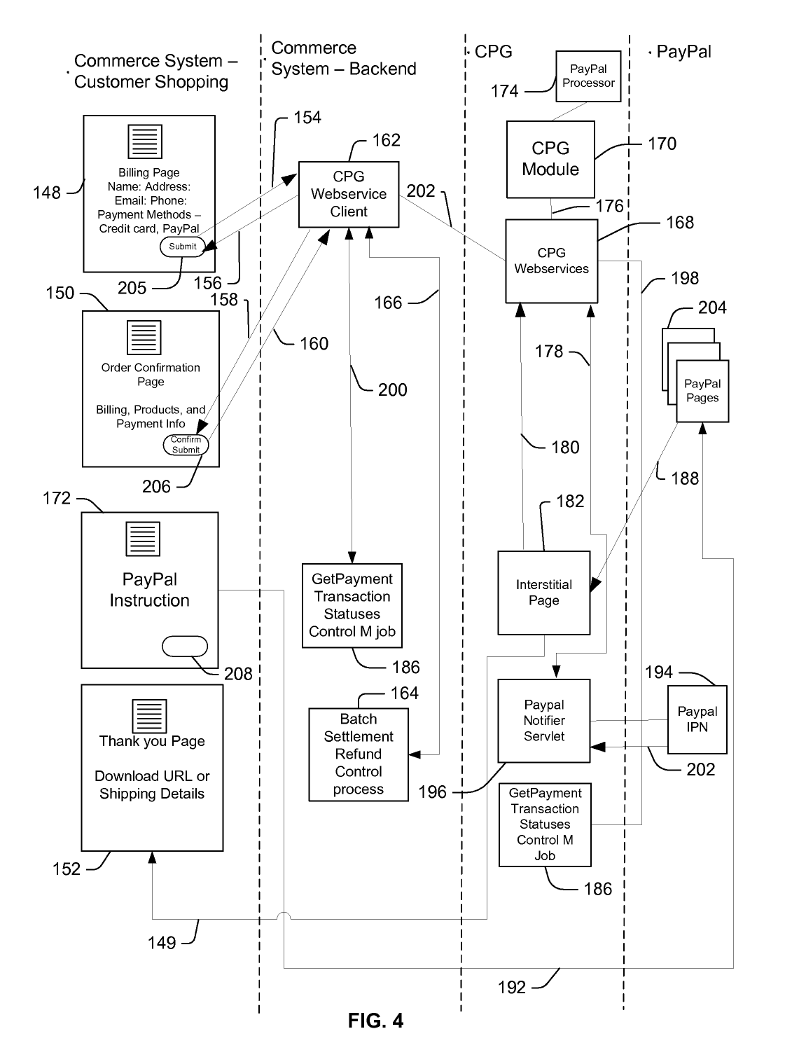

Referring now to FIG. 4, a PayPal redirect flow diagram is shown. PayPal authorization follows a different page flow. It will be understood by one of ordinary skill in the art that a similar flow may occur for other browser-redirection payment schemes. Basically, the customer selects a payment type of PayPal and enters their email address on the billing page 148. The billing page 148 is where error handling, display error messages, and messages specific to the payment method, such as currency, occur. These messages can also occur on an order confirmation page 150, infra. In another preferred embodiment of CPG, the ecommerce system then stores the email address into CPG Web Service client 162 and receives a token in return. Clicking submit 205 stores the request 154 to CPG Webservice Client 162 and then a store response 156 is sent back. The customer next sees the order confirmation page 150. After the customer confirms 206 that they wish to order, the ecommerce system sends calls to authorize to CPG Webservice Client 162. These calls are Authorize request 160 and Authorize response 158. CPG Module 170 uses PayPal service adapter (processor) 174 to construct a URL that will redirect the customer's browser to PayPal. This URL contains the order ID, the browser session ID, a reference ID, purchase amount, and other data. CPG will mark the authorization transaction as being in “Submitting” status. The PayPal processor 174, on authorize request 160, will provide the redirect URL along with the authorize response 158. Then it will look up payment transaction status and refund the payment transaction, then process the batch returns. Batch Settlement Refund Control process 164 is where the batch settlement occurs. CPG Webservice Client 162 gets 200 the statuses of unconfirmed transactions with PayPal (GetPayment Transaction Statuses Control M Job 186) on regular intervals. CPG webservice 162 communicates 166 with a Batch Settlement Refund Control 164 for refund regulation.

The customer is then sent to a page 172 explaining that they are about to leave the ecommerce site and go to PayPal. There will be a PayPal button 208 that uses the redirect URL for payment confirmation. Next, the customer logs into and is redirected 192 to PayPal 204 and verifies that they wish to make a payment. The customer's browser is then redirected 188 to an “interstitial page” servlet 182 hosted by the company. PayPal sends along the order ID, the session ID, the reference ID and the PayPal transaction ID. The interstitial page 182 will look up 180 the order in CPG. If the payment is not yet completed, the page will retry every five seconds up to three times. Basically, PayPal will redirect to the commerce system. The interstitial page 182 look ups 180 with CPG, inquiring about the status. On successful status, there is a release of the order and then redirected 149 to either the thank-you page 152 or an error handling page. The thank-you page 152 is the common page for all payment methods, and upon payment confirmation the order will be released for fullfilment.

The servlet 182 then re-establishes the user's browser session. After they confirm payment, PayPal will communicate 202 through their Instant Payment Network (IPN) protocol 194 to the PayPal Notifier Servlet 196 hosted by the company. This communication 202 is to verify and notify with an IPN message. The IPN message contains the status of the PayPal transaction, and sends the order ID, the reference ID, and the PayPal transaction ID. This servlet 196 then updates 178 CPG webservices 168 and module 170 to change the status of the authorization transaction to “Completed” for this order. When the order is completed, the customer is redirected to the thank-you page 152. Upon reaching the thank-you page 152, the ecommerce system can mark this order as having been authorized for payment. It is possible that a customer will complete payment, but never get to the thank-you page 152. To handle this, the ecommerce system runs a periodic job that looks up pending orders in CPG. If a payment is discovered to be completed, the order should be marked as authorized. When the order is fulfilled, another background process calls the settlement web service 164. CPG also runs a periodic process 198 that checks for transactions that have not completed (to GetPayment Transaction Statuses Control M Job 186). If a “Submitting” transaction is more than 24 hours old, its status is changed to “Failed”.

If the customer fails to log into PayPal, then no IPN message will be sent. In this case, the authorization transaction will remain in “Submitting” status, and the ecommerce system should not consider it authorized. After 24 hours, CPG will change the status to “Failed”. If the customer logs into PayPal, but refuses to authorize payment, PayPal will send an IPN message indicating this refusal. The transaction will remain in “Submitting” until it is later failed. PayPal will redirect the customer to a URL for cancelled payments. If the customer completes the PayPal authorization, but kills their browser before reaching the thank-you page 152, the CPG transaction will still have been marked as “Completed”. The ecommerce system periodically performs lookups on pending orders to see if they have been authorized. If the reference ID is detected as wrong, it indicates that someone may be trying to hack the system by communicating directly to the PayPal Notifier Servlet 196 or the interstitial page 182. The transaction is marked as “Failed” and the incident logged.

Refunds are initiated by customer service on the ecommerce platform. The refund is then pushed to CPG and later handled by a PayPal API web service. Customer service requests a refund on an existing order. The ecommerce system sends the refund to CPG through web services. CPG uses a PayPal adapter to make a call to PayPal's web service APIs. The adapter then records the refund as a payment transaction within CPG. PayPal sends a message though IPN to the Notifier servlet with a payment status of “Refunded”. The message is ignored, since the adapter has already persisted the refund status. Chargebacks are pushed to CPG through the IPN notifier servlet. When PayPal registers a chargeback against a previous transaction, it sends an IPN message with a payment status of “Reversed”, a reason code of “chargeback”, and the transaction ID from the parent settlement transaction. The notifier servlet calls the chargeback web service. The CPG module will look up the original settlement transaction to get the order ID, and will then create a new payment transaction to record the chargeback. Later, a periodic job on the commerce system will get all new payment transaction statuses. It will get the new chargeback transaction and match it up with the original order.

The billing page 148, order confirmation page 150, PayPal instruction 172, and thank-you page 152 are all part of the commerce system customer shopping section. The CPG webservice 162, Batch Settlement Refund control 164, and GetPayment Transction Statuses Control M Job 186 function in the backend of the commerce system. CPG module 170, CPG webservices 168, PayPal processor 174, interstitial page 182, PayPal Notifier servlet 196, and GetPayment Transction Statuses Control M Job 186 are CPG collectively. Finally, PayPal 204 and PayPal IPN 194 are the PayPal section of the flow diagram in FIG. 4.

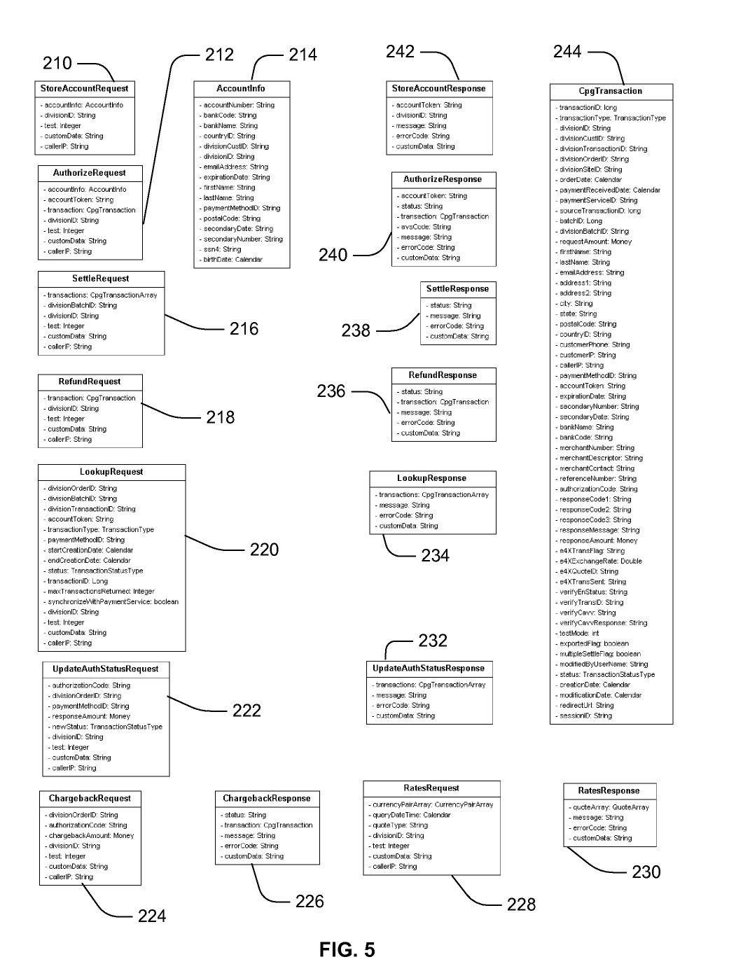

FIG. 5 shows how commerce systems access the CPG functions through web services, as defined by a Web Services Definition Language (WSDL) document. These are objects sent and received when a client platform communicates to CPG.

CPGTransaction 244 is an object representing a financial transaction made for one CustomerAccount or one commerce division. A purchase may involve several transactions, typically including authorization, settlement, refund, chargeback, etc. Each transaction contains a unique ID assignted to it after CPG has processed the transaction. The life cycle of payments in CPG is modeled on credit card transactions, even for payments that are fairly different from credit cards. In this life cycle, creidt is authorized at the time of purchase, settled after the order is fulfilled, and ultimately funded when money is transferred to a bank account. Each transaction has a status value, such as “Completed”, “Failed”, “Declined”, or “Cancelled”. Sometimes a transaction will change status. For instance, it might move from “Pending Data” to “Pending Funding” to “Completed”.

StoreAccountRequest 210 is a message requesting that a new Customer Account object be defined in CPG. This account is defined by an account token and a division ID. The account usually represents one credit card or bank account.

AccountInfo 214 is an object encapsulating a credit card, bank account, or other payment account. StoreAccountResponse 242 is a message responding to StoreAccountRequest 210. This contains either a new account token or an error message.

AuthorizeRequest 212 is a message requesting that credit be authorized. AuthorizeRequest 212 must contian either complete AccountInfo 214 or else an account token and division ID. It will contain one CPGTransaction 244 without an ID. Authorizations are always processed in real time. The commerce divisions get back an authorization decision immediately.

AuthorizeResponse 240 is a message responding to the AuthorizeRequest 212. It contains the CPGTransaction 244 with an assigned ID. SettleRequest 216 is a message requesting that one or more payments be settled. This message contains a list of CPGTransactions 244 of type “Settle”. Each transaction should contain a reference to the ID of the corresponding authorization transaction. The commerce division may assign a batch ID to this request so it can later look up the status of settlements. CPG often does not settle transactions immediately. Often, they are accumlated into batches and then submited to the payment processors overnight. Commerce divisions must later look up the status to see if they process successfully.

SettleResponse 238 is a message responding to a SettleRequest 216. RefundRequest 218 is a message requesting that an existing settlment transaction be refunded. RefundResponse 236 is a message responding to the RefundRequest 218. LookupRequest 220 is a message requesting the status of CPGTransactiosn 244. Transactions can be looked up by many different criteria, including specific order numbers, transaction IDs, and date ranges. Commerce divisions can look up predifined batches of transactions.

LookupResponse 234 is a message responding to the LookupRequest 220. This contains an array of transactions. UpdateAuthStatusRequest 222 is a message requesting that an authorization transaction change status. This is only possible for certain payment methods where the commerce division plays a part in completing the authorization. UpdateAuthStatusResponse 232 is a message responding to the UpdateAuthStatusRequest 222.

ChargebackRequest 224 is a message notifying CPG that a payment service is refunding money to the customer. This transaction is almost never transmitted through the web service. Most chargeback transactions are created by back-end processes that receive different communications from the payment services. ChargebackResponse 226 is a message responding to ChargebackRequest 224.

RatesRequest 228 is a message requesting currency exchange rates. This may be for a specific currency pair, or it may be a request for all exchange rates. Finally, RatesResponse 230 is a message responding to the RatesRequest 228 message.

If CPG encounters and error condition, it will communicate the error back in the “status” and “message” fields. For instance, if a refund has a different currency that the original settlement, this will return a “Failed” status. Simple object access protocol (SOAP) faults may be sent back for extraordinary errors, such as unexpected database failures. Although this is not part of normal processing, all ecommerce systems must be prepared to gracefully handle faults.

Most payments go through the steps of accounting, authorizing, and settling. For store accounts, a customer's division ID and account information is saved, and an account token is generated. CPG checks to see if there is already an account that matches this combination of account number, payment type, and division. If an account exists, the account token is returned. If an account matches for this account number, and payment type, but in a different division, a new account is created with the same account token, but a different division number. This account token is returned. If no token is found, a new account is created with the customer's information. The token for this new account is returned. The way that accounts are matched depends on the payment type. For credit card payments, CPG will attempt to match customer accounts based on the credit card number. For PayPal, CPG will look for accounts with the same email address.

For authorizing, a payment service is chosen for the transaction and then authorized. Optionally, this method can also save the customer's account, so some ecommerce platforms can perform both store and authorize in the same web service call. CPG creates a list of payment processors applicable to this ecommerce platform, merchant site, currency, country, and payment type. CPG will sort the list depending on which payment processors are most appropriate. The most desirable payment service is tried first. If communication fails, the next payment service is tried. Communication ends after one of the payment services either authorizes or rejects the transaction. The payment service will send back an authorization code for all successful transactions. For example, with PayPal, there will be only one payment service option. The chosen payment service will be attached to the transaction, so subsequent settlement actions will execute against this payment service. For browser-based payment schemes (such as PayPal), this call will also send back a redirect URL to reach the provider's site. This URL may contain the session ID or order ID in encrypted form.

For settlement, a list of transactions that have previously been authorized will be settled. All transactions in the list must be for the same payment processor. CPG accumulates transactions into a batch. The list may also contain refund transactions. For most conventional credit card processors, the transactions are accumulated into a batch for processing later. All settlement transactions within the batch have a status of “New”. CPG will transmit the whole batch to the payment processor. The ecommerce system can later retrieve the status of the settlements by doing a lookup of all transactions with the given divisionBatchID. For PayPal, the payment is actually settled at the same time as authorization. In other words, the ecommerce system is guaranteed to receive payment as soon as authorization is completed. However, PayPal orders will still go through a settlement phase after the order is fulfilled. CPG will create a settlement payment transaction, but will not communicate to PayPal for settlement. Refund transactions, however, are transmitted directly to PayPal. All payment transactions will have a status of “Completed”.

The ecommerce systems can look up payment transactions meeting specific criteria. For instance, they may request all transactions for a given divisionOrderID or for a divisionBatchID.

### The Following Queries Will Be Supported

divisionID, divisionOrderID, transactionType (optional)
divisionID, divisionTransactionID
accountToken, divisionID, transactionType (optional)
divisionID, startPaymentDate, endPaymentDate
divisionID, batchID
divisionID, divisionBatchID
divisionID, startCreationDate, endCreationDate, transactionType (optional)
Valid transactionTypes are Authorize, Settle, Refund, Chargeback, Cancelation.

Table 2(shown below) outlines some of the performance queries in logging and notifications for CPG. For logging and notifications CPG will use the standard logging framework built into Java. This framework allows programmers to create “logger” objects for reporting the status of CPG code. After code is written, administrators can attach a “handler” to each named logger. The handler specifies where logging information is exported. An administrator can specify that some handlers save messages to files, some handlers save to the database, and certain handlers cause email or pager communication. Each log message has a severity level. The Java logging framework supports the following severity levels: SEVERE, WARNING, INFO, CONFIG, FINE, FINER, and FINEST. The SEVERE level should only be used to report a failure of service. The WARNING level should only be used to report situations that could potentially lead to a failure of service. Log messages should never contain sensitive information, such as credit card numbers. For normal logging, each logger has a name. The default practice should be to use the current package name as the logger name. For instance, all the code in the PayPal adapter package can use the logger named “com.digitalriver.cpg.payment.adapter.paypal”.

Furthermore, every java exception should be logged. Depending on the situation, exceptions should have a severity of either SEVERE, WARNING, or INFO. Each should begin with the transaction ID and then at least one blank space. If there is no known transaction ID, the message should begin with a hyphen and a space. Messages of severity FINE, FINER, or FINEST are usually only watched by software developers.

TABLE 2

Logger.logger =
Logger.getLogger(“com.digitalriver.cpg.payment.adapter.chase”);
logger.severe(paymentTrans.getTransactionID( )+“Failed to
authorize”);
logger.fine(paymentTrans.getTransactionID( )+“Return from
authorize [Pymt:“ + t + ” milliseconds]”);
logger.warning(“-Web service failure”);

In performance logging, whenever an adapter makes a communication out to a payment processor, the call should be preceded by a FINE message of the form “Calling service name”. When the communication call returns, log another FINE message of the form “Return from service name n milliseconds”. Also, external communications will always be timed. Slow database queries may be timed and reported using a FINE message, but this is optional. Hibernate generates log messages of its own, so they do not require extra logging. Moreover, in notification of loggers, there will be a logger called “support.cpg”, which will be used to send messages to the hardware and software support staff for CPG. Assume that a SEVERE message to support.cpg will always cause an administrator to be paged. Assume that a WARNING message may cause either a page or an email message. Do not send debugging information to these loggers (FINE, FINER, or FINEST). For each payment processor, there will be a specific logger to send messages about this adapter. For instance, communication problems with PaymenTech might be logged to “support.cpg.paymentech”.

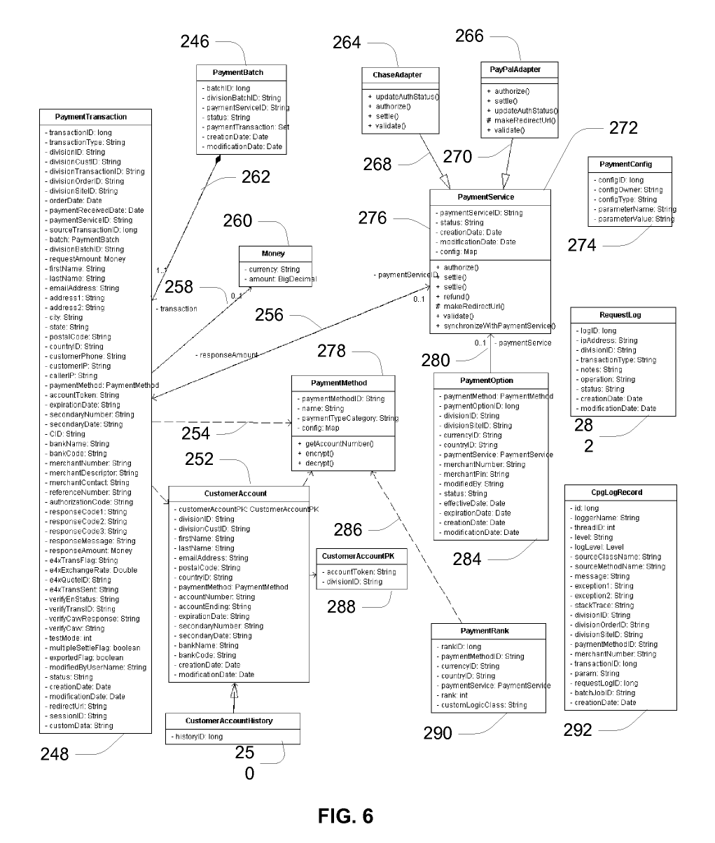

FIG. 6 shows a diagram of persistent classes and CPG. This figure also shows objects saved in database tables. CPG uses object-relational layers to translate rows in the database into Java Objects. PaymentTransaction 248 represents one financial transaction made with a a payment service. Each transaction has a tpe such as “authorize” or “settle” and a status such as “completed” or “failed”. Each transaction has a unique ID assigned when it is saved to the database. These objects are taken from a CPG_PAYMENT_TRANSACTION table. These objects are translated to CPGTransactions 244 when communciated through the web service.

PaymentBatch 246 represents a group of PaymentTransactions 248. All transactions in a batch are of the same type. A batch has an overall status such as “completed” or “failed”, indicating its complete processing status. These objects are documented in the CPG_PAYMENT_BATCH table. They are transated into arrays of CPGTransactions 244 when communicated through the web service.

CustomerAccount 252 encapsulates a customer's identity and credit card information. Each account is identified by an acount token and division ID. The actual credit card information is encrypted, and most transactions can be executed using just the token. These objects are stored in a CPG_CUSTOMER_ACCOUNT table. The web service may construct them based on AccountInfo objects. CustomerAccountHistory 250 contains historical data whenever a customer account is edited. It is kept in a CPG_CUSTOMER_ACCOUNT_HIST table.

PaymentMethod 278 represents a specific type of payment, such as Visa, MasterCard, Paypal, or wire transfer. Commerce divisions identify their customer accounts as using a payment method, without having to worry about what payment service will process it. These objects are stored in a CPG_PAYMENT_METHOD table. This table is small and table. There are a relatively small number of payment methods. The identity of the payment method is communicated in CPGTransactions 244 using a method ID string, such as “Visa”.

PaymentService 276 represents one payment processor that handles transactions for CPG. There may be multiple payment services for a given payment method (e.g., Visa can be handled by several services). A given service may handle multiple methods. For example, Paymentech may handle Visa, MasterCard, and Discover. In some cases the payment sevices seems identical to the method (e.g. PayPal transactions are only processed by the Paypal Corporation). These objects are stored in a CPG_PAYMENT_SERVICE table. In the web service, they are identified by a payment service string such as “Paymentech”.

PaymentConfig 274 is extra information that may be retrieved for a payment service, payment method, payment option, or commerce division. These configuration parameters are stored in a CPG_PAYMENT_CONFIG table. PaymentOption 284 specifies that a given payment service and payment method is available for a given merchant ID, merchant site ID, currency ID, and country. When a commerce division requests authorization, CPG goes through a complex algorithm to create an ordered list of payment services that can handle it. The payment optons are used to build this list. This algorithm can be used to pcik the most advantageous services in each situation. Each payment option contains a merchant ID number (MID) which shows where the revenue will be reported back to the accounting systems. These objects are maintained in a CPG_PAYMENT_OPTION table.

PaymentRank 290 specifies additional information attached to a payment option, depending on the country and currency of a transaction. This data may be used to indicate that some options are preferable, depending on the transaction details. This data iskept in the CPG_PAYMENT_RANK table. RequestLog 282 represents a single web service call into CPG. These logs can be used to reconstruct all the log data for a given call. This is stored in a CPG_REQUEST_LOG table.

CPGLogRecord 292 contains the record of some event within CPG. These records are often linked to request logs, orders, or transactions. Log records are created everywhere within the CPG code. They can be retrieved from the database to get a detailed account of each request or transaction. These records are stored in a CPG_LOG table. CPG uses the standard Java logging mechanism, augmented by special handlers that save the information to the database.

Internally, CPG accomplishes its functionality with the following persistent classes: PaymentBatch, Payment Transaction, ChaseAdapter, Money, Payment Method, Customer Account, CustomerAccountPK, Customer Account History, Payment Rank, Cpg Log Record, Payment Service, Payment Option, Request Log, Payment Config, and PayPal adapter.

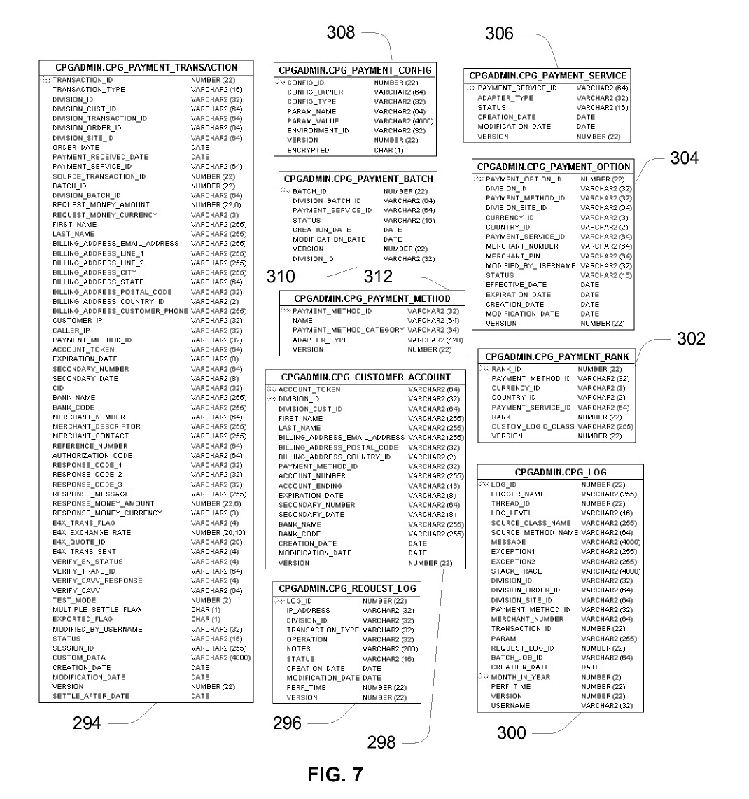

FIG. 7 shows persistent classes stored in an Oracle database. Java code will use a Hibernate framework to persist data into the database. For dependencies, data will be persisted into an Oracle database. Web services will run under OC4J (Oracle Containers for Java), a J2EE (Java 2 enterprise edition platform) application server. In addition, for deployment and configuration issues data persistence is performed using Hibernate. Database parameters, such as username and password, are stored in the file hibernate.cfg.xml, which must be placed on the classpath. Payment adapters may be configured with the database table CPG_PAYMENT_CONFIG. Unit tests and functional tests will be organized so they can be easily reused as new payment services are added.

CPGAdmin.CPG_PAYMENT_TRANSACTION 294 contains financial transactiosn executed by CPG. Each transaction is uniquely identifed by a number, assigned when the transaction is created. CPGAdmin.CPG_PAYMENT_BATCH 310 represents logical collections of transactions. Each batch has a unique number identifying it. Each batch has an overall status indicating the success of the batch processing. A transaction can be in at most one batch. CPGAdmin.CPG_CUSTOMER_ACCOUNT 298 represents one credit card or business account used in transactions. Each account is identified by an account token and the division ID. Account tokens may be duplicated for different commerce divisions; in fact CPG attempts to assign the same token if a credit card is used in more than one division. CPGAdmin.CPG_PAYMENT_METHOD 312 represents one type of payment. Methods are uniquely identified by their method ID string, such as Visa, MasterCard, or PayPal. CPGAdmin.CPG_PAYMENT_SERVICE 306 represents one service who processes payments for CPG. Services are uniquely identified by their service ID string, such as “paymentech”, “netgiro”, or “paypal”.

CPGAdmin.CPG_PAYMENT_CONFIG 308 defines configuration options that can be retrieved for other objects. CPGAdmin.CPG_OPTION 304 links payment services to combinations of division, service, method, currency, etc. CPGAdmin.CPG_PAYMENT_RANK 302 allows payment options to be ranked, depending n currency and country of transaction. CPGAdmin.CPG_REQUEST_LOG 296 records web service activity, and CPGAdmin.CPG_LOG 300 records CPG processing activity.

### CPG Supports Three Categories of Payment Processors

Direct processing: CPG makes a connection directly to the payment processors for authorization and settlement.
Browser redirect processing: The user's browser is redirected to the payment processor's web site. After payment is made, the processor will communicate status back to CPG.
Delayed payment: The user indicates that payment will be handled at a later time.

### System Requirements

CPG is capable of storing all secure shopper transaction data. CPG consists of payment adapters, application server, Web server, APIs, data cleanser, database, and other modules, as deemed appropriate by designers. Secure transaction data includes credit card numbers, Card Verification Value codes (CVV), and verified by Visa authorization codes. Commerce systems should not persist sensitive transaction data, such as credit card numbers. CPG is available for use by a variety of ecommerce systems. CPG offers a single point of integration for all ecommerce systems and payment processors. Integration point is made up of several APIs, including Direct Connect, Web Services, etc.

### Distribution and Redundancy

CPG is available in a variety of ecommerce company data centers. It stores secure transaction data from the order taker databases physically in that data center. For example, a United Kingdom (UK) data center contains three order taker databases. All secure transaction data from the databases will be copied to the CPG in the UK data center. All secure data from the data center CPG shall be copied to a centralized CPG in a United States (US) data center. Each data center will have a minimum of one redundant CPG that mirrors the data in the case of failure of the primary CPG.

### Data Communication Link

Any e-commerce system may communicate all transaction data to the CPG via web services. All transactions will be sent to the CPG in XML data format.

### Security

CPG protects data stored in the CPG. CPG utilizes a security envelope to protect against unauthorized access of secure transaction data. Access to the data within the CPG is only allowed through a separate, secure IP address. Data transferred into and out of the CPG is encrypted. CPG is protected by a firewall. To protect the data, NAT (Network Address Translation) is not allowed for accessing the CPG.

### Secure Sockets Layer (SSL) Communication from Web Servers to CPG

Eeb services are protected by usernames and passwords, using Basic Authentication. Ecommerce systems are prevented from initiating transactions or performing lookups against the division IDs of other e-commerce systems. Many payment processors do not support SSL because they lack decryption capability. Therefore, to protect the data communications from the CPG to the payment processors, direct connections into the payment processors (i.e., PaymenTech and Chase) may be used. Data should be encrypted whenever it is being transferred via an Ethernet. Access accounts should be established for Web Services. Accordingly, users should provide their credentials before connecting to the CPG Web Service.

### Logging Transactions

In another preferred embodiment, CPG records transactions performed by the CPG for audit trail purposes. Transaction data is persisted in a database and is available for reporting. Error events are used to trigger the generation of notifications. Secure transaction data is removed before logging the transactions.

### Service Fees

In a preferred embodiment, CPG tracks payment method use rates. Fees are typically provided via flat file on a per transaction basis. Also, CPG monitors interchange rates. For example, an interchange rate may be 1.85% or 1.9%. It will be understood, for example, that some Visa rates are 2.58%.

### Accounting

CPG prefers that commerce platforms to settle transactions at the same time, with each payment provider each day. Commerce systems can submit settlements at any time, but the settlement batch should contain transactions for a single business day. This ensures that the transactions and the settlement batch are reconciled for the same business day, for reconciliation to the specific commerce system's sales reports.

Fees directly impact the amount of money funded into an ecommerce system bank account and decrease the total amount of settlement. CPG aligns the fees by payment providers and charges the ecommerce system with each transaction.

### CPG Settlement Architecture

CPG uses a batch queue approach to settling payments from e-commerce platforms. Commerce systems can send settlements to the CPG, which may store them and send them to the payment processors in batches on a pre-defined schedule. Commerce systems can later retrieve the results for a given batch. A best practice is to ensure that all settlements in a batch are for the same business day. This allows a commerce system to easily retrieve a complete business day's settlements for accounting purposes.

### Media Identification Code (MID) creation

In a preferred embodiment, CPG can support a standard setup of MID's across any payment providers. CPG should support the existing MID's from all commerce system.

### Payment Processor Selection

In another preferred embodiment, CPG supports dynamic selection of a payment processor based financial advantage to an ecommerce system. CPG allows administrators to specify which processors are preferred for any combination of payment type, currency, and country.

For example, with Verified by Visa, the commerce system redirects the shopper's browser to Visa for authorization of the password. After verification, the shopper returns to the site to complete the transaction. The purpose of this project is to create a payment processing solution that is available for use by a variety of ecommerce systems. A centralized payment gateway solution provides a single point of integration for all systems, improves manageability of data by storing it in a central location, improves security of sensitive data, and reduces redundant payment adapter solutions.

### USE CASES

### Use Case 1: Store Customer Account

Summary Sensitive customer account information is persisted to the database and a token is generated to represent this data. If an account already exists for this information, the token for the existing account is retrieved.
Primary actor: Ecommerce System
Minimal guarantees There is a customer account in the database, with a unique token.
Basic course of events: CPG checks to see if there is already an account that matches this combination of account number, payment type, and division. If an account exists, the account token is returned. If an account matches for this account number, and payment type, but in a different division, a new account is created with the same account token, but a different division number. This account token is returned. If no token is found, a new account is created with the customer's information. The token for this new account is returned. Extensions matching logic may be different for each payment type.

### Use Case Name 2: Authorize Payment

Summary: The ecommerce system checks that the payment processor recognizes this account information, and that the customer has sufficient credit to purchase for a specific amount. The payment processor may reduce the customer's available credit.
Primary actor: Ecommerce System
Preconditions: Customer Account already exists with an Account Token.
Minimal guarantees: After processing, the transaction will be assigned a status of either COMPLETED, PENDING, or FAILED.
Success guarantees: The payment processor will return an authorization code for this transaction, indicating that the customer may make this purchase. The transaction will have a status of COMPLETED. Whenever possible, the Address Verification Service (AVS) code will be returned. The commerce system may use the AVS code for fraud screening.
Basic course of events: CPG determines the most appropriate payment processor for the given ecommerce system, merchant store, currency, country, and payment type. CPG requests authorization for this purchase. If communication fails, CPG tries to authorize with the next most appropriate payment processor, and continues to retry until a payment processor can be reached. If no payment processors can be reached, CPG will mark this transaction as FAILED and report an error. CPG will also support an authorization call with just an account number, but without a token. In this case, CPG will retrieve or create the token.

### Use Case Name 3: Batch Settlement

Summary: The Ecommerce System seeks to settle a batch of previously authorized transactions.
Primary actor: Ecommerce System
Preconditions: Customer Accounts already exist for all transactions. All transactions in the batch are for the same payment processor, and all have unique authorization codes.
Minimal guarantees: After processing, each transaction will be assigned a status of either COMPLETED or FAILED.
Success guarantees: CPG will return the batch ID number.
Basic course of events: Submit batch of settlements to the payment processor. Return a list of all transactions and statuses.

### Use Case Name 4: Order Status Lookup

Summary: Ecommerce System may request the current status of an order's authorization or settlement, based on the division and the division's order ID.
Primary actor: Ecommerce System
Success guarantees: A list of payment transactions will be returned.
Basic course of events: Retrieve the given order's status. If not found, report an error.
Extensions: The following queries will be supported:
   divisionID, divisionOrderID, transactionType (optional)
   divisionID, divisionTransactionID
   accountToken, divisionID, transactionType (optional)
   For fraud divisionID is optional
   divisionID, startPaymentDate, endPaymentDate
   divisionID, batchID
   divisionID, divisionBatchID
   divisionID, startCreationDate, endCreationDate, transactionType (optional

### Use Case Name 5: Refund

Summary: The Ecommerce System requests that some or all of the settled payment on an order be refunded to the customer. This will be accomplished by making a settlement transaction for a refunded amount.
Primary actor: Ecommerce System
Preconditions: Authorization and settlement records must already exist for this division ID and order ID.
Minimal guarantees: After processing, the new transaction will be assigned a status of either COMPLETED or FAILED.
Success guarantees: A new refund transaction will be recorded a status of COMPLETED.

It will be understood by one of ordinary skill in the art that ecommerce systems may only refund payments settled by their own division ID. Total refund may not exceed the total amount settled. Refunds must be in the same currency as the settlement. In some cases, additional information may be necessary, such as the bank name, bank country, and bank account number. Refunds may be delayed.

### Use Case Name 6: Cancellation

Summary: Cancel a previously executed transaction.
Primary actor: Ecommerce System
Preconditions: Original transaction must exist.
Minimal guarantees: A new payment transaction record will exist documenting this cancellation.

### Use Case Name 7: Chargebacks

Summary: Customer complains to the payment processor and has a charge reversed. CPG will document these transactions.
Primary actor: Payment processor
Preconditions: Settled payment transaction already exists for this transaction.
Minimal guarantees: A payment transaction will exist for this chargeback.
Basic course of events: CPG receives the chargeback information, creates transaction records and associates them with the original settlement.

Table 3, shown below, is a sample query performed in the commerce back end of CPG. This algorithm, or SQL database logic, determines the most specific payment service and the least specific payment service type. The arbitration engine matches the division ID, site ID, and payment methods. It also determines whether payment methods, currency IDs, country IDs, category fields are blank (null).

```
TABLE 3
String stmt = “from PaymentOption as PO”
    + “where PO.paymentService.-
    paymentServiceID=:paymentServiceID ”
    + “and PO.divisionID=:divisionID ”
    + “and (PO.divisionSiteID=:divisionSiteID or PO.divisionSiteID
    is NULL) ”
    + “and PO.paymentMethod.paymentMethodID=:paymentMethodID ”
    + “and (PO.currencyID=:currencyID or PO.currencyID is NULL) ”
    + “and (PO.countryID=:countryID or PO.countryID is NULL) ”
    + “and (PO.midCategory=:midCategory or PO.midCategory is
    NULL) ”
    + “and PO.status=:activeStatus ”
    + “order by PO.divisionSiteID, PO.entityCode, PO.midCategory,
    PO.countryID, PO.currencyID”;
Query query = session.createQuery(stmt);
query.setString(“paymentServiceID”, paymentServiceID);
query.setString(“divisionID”, divisionID);
query.setString(“divisionSiteID”, divisionSiteID);
paymentMethodID = StringUtils.trimToEmpty(paymentMethodID);
query.setString(“paymentMethodID”, paymentMethodID);
query.setString(“currencyID”, currencyID);
query.setString(“countryID”, countryID);
query.setString(“midCategory”, midCategory);
query.setString (“activeStatus”, “active”);
```

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different communication protocols may be organized or designed differently while maintaining substantially the same functionality and without departing from the scope and spirit of the present invention.

What is claimed is:

1. A computer based system having a software module programmed to enable more than one electronic commerce platform to communicate through a web service based application programming interface to more than one payment service provider.

2. A web service for providing a payment service arbitration engine, the web service being operatively configured to obtain user data from at least one electronic commerce platform and to determine an optimal payment service provider based upon the obtained user data.

3. A method for arbitrating between various payment service providers, comprising steps of:
obtaining user data from at least one electronic commerce platform; and
determining an optimal payment service provider based upon the obtained user data as well as currency requirements, exchange rates, transaction fees, and service provider location.

4. The method of claim 3 further comprising steps performed by a user interacting with the electronic commerce platform during a payment process of selecting payment method and entering payment information.

5. The method of claim 3 further comprising steps of:
communicating to platform to send payment information to a web service;
communicating to platform to send authorization requests to the web service; and
sending authorization response to platform.

6. The method of claim 5 further comprising a step of continuing a checkout process at the electronic commerce platform after the authorization response is received.

7. The method of claim 5 further comprising a step of fulfilling an order at the electronic commerce platform by sending a settlement request to a web service.

8. The method of claim 3 further comprising steps of:
constructing a Uniform Resource Locator (URL) for a payment process service provider;
redirecting customer to the URL; and
verifying customer's payment from the payment process service provider.

9. The method of claim 8 further comprising a step of sending a communication to the electronic commerce platform that causes the platform to release a customer order after verifying the customer's payment for the customer order.
